(19) United States
(12) Patent Application Publication
(10) Pub. No.: US 2006/0104448 A1
(43) Pub. Date: May 18, 2006

(54) Data transmission method and apparatus and data receiving method and apparatus for multiple access in chaotic communication system

(75) Inventors: Nam-hyong Kim, Seoul (KR); Young-hwan Kim, Hwaseong-gun (KR); In-hwan Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/273,402

(22) Filed: Nov. 15, 2005

(30) Foreign Application Priority Data
Nov. 15, 2004 (KR) 10-2004-0092971

(51) Int. Cl. H04L 9/00

(52) U.S. Cl. 380/263

(57) ABSTRACT

A data transmission method and apparatus and a data receiving method and apparatus provide for multiple access in a chaotic communication system. The data transmission method includes arranging a template chaotic signal at a predetermined position of a data frame to be transmitted, the predetermined position being allocated to a user, modulating a data source signal using the template chaotic signal and arranging the modulated data source signal in the data frame, and transmitting the data frame.

### CROSS-REFERENCE TO RELATED PATENT APPLICATIONS

This application claims the priority of Korean Patent Application No. 10-2004-0092971, filed on Nov. 15, 2004, in the Korean Intellectual Property Office, the disclosure of which is incorporated herein in its entirety by reference.

### BACKGROUND OF THE INVENTION

1. Field of the Invention

The present invention relates to a chaotic communication system, and more particularly, to a data transmission method and apparatus and a data receiving method and apparatus for enabling multiple access in a chaotic communication system.

2. Description of the Related Art

To transmit data at high speed, conventional wireless standards require more power and complicated structure. However, most of the industrial or home wireless monitoring and control applications require a communication system that have a longer battery life and less complicated structure even if the system cannot transmit data at high speed. For wireless applications, IEEE 802.15 Task Group 4 has suggested a standard for a system that has low efficiency of transmission but a long battery life and a less complicated structure. Wireless applications can be used for home automation applications such as wireless sensors, interactive toys, smart badges, and home remote control devices. IEEE 802.15.4 defines a physical (PHY) layer and a MAC layer for the wireless applications.

Zigbee is a wireless networking standard for remote control and sensor applications in harsh radio environments or isolated places. Zigbee defines applications at an upper layer for the interoperability between products manufactured by different manufacturers, and defines security layer specifications.

At present, the IEEE 802.15.4a (UWB broadband) standard is being updated to replace the existing Zigbee PHY layer with a new PHY layer.

Therefore, much attention has been paid to a chaotic communication system aimed by the IEEE 802.15.4a standard and the Zigbee standard, which have a low rate of data transmission but a less complicated construction and which consume less power.

Information output from the chaotic communication system is transmitted from a transmission side to a receiving side in response to a chaotic signal. Advantages of the chaotic communication system are apparent from the characteristics of the chaotic signal. The chaotic signal has a broadband continuous spectrum, is very sensitive to initial conditions, and can be generated by a circuit that has a simple construction and stable characteristics and can be manufactured at low cost.

A chaotic communication system having a simple RF process is a low transmission efficiency system that is covered by the Zigbee standard and that requires a tradeoff between complexity and throughput. However, such a chaotic communication system has the disadvantage that a chaotic signal must be controlled or reproduced differently according to the type of system. Specifically, there are problems with the multiple access/simultaneously operating piconet schemes since the reproducibility of the signal is lacking.

### SUMMARY OF THE INVENTION

Apparatuses and methods consistent with the present invention provide for transmitting and receiving data in a multiple access, chaotic communication system.

According to one aspect of the present invention, there is provided a method of transmitting data for a multiple access in a chaotic communication system, the method comprising arranging a template chaotic signal at a predetermined position of a data frame to be transmitted, the predetermined portion being allocated to a user, modulating a data source signal using the template chaotic signal and arranging the modulated data source signal in the data frame, and transmitting the data frame.

During the arranging of the template chaotic signal, positions of the data frame, which are allocated to other users, may be unoccupied.

According to another aspect of the present invention, there is provided a method of receiving data for a multiple access in a chaotic communication system, the method comprising receiving a data frame via a multichannel; detecting a template chaotic signal at a predetermined position of the data frame, the predetermined position being allocated to a user; and extracting a data source signal from the data frame using the template chaotic signal.

During the extracting of the data source signal, the data source signal may be extracted from the data frame according to the correlation between the template chaotic signal and a corresponding data bit frame of the data frame.

According to yet another aspect of the present invention, there is provided an apparatus for transmitting data for a multiple access in a chaotic communication system, the apparatus comprising a chaotic signal generator arranging a template chaotic signal at a predetermined position of a data frame to be transmitted, the predetermined position being allocated to a user; a data bit frame generator combining the template chaotic signal with a data source signal to be transmitted, and including the result of combining into the data frame; and a data transmission unit transmitting the data frame.

The chaotic signal generator prevents arranging signals at positions of the data frame which are allocated to other users.

According to still another aspect of the present invention, there is provided an apparatus for receiving data for a multiple access in a chaotic communication system, the apparatus comprising a data receiving unit receiving a data frame via a multichannel; a template detector detecting a template chaotic signal at a predetermined portion of the data frame, the predetermined position being allocated to a user; and a data extracting unit extracting a data source signal from the data frame using the template chaotic signal.

The data extracting unit may extract the data source signal according to the correlation between the template chaotic signal and a corresponding bit frame of the data frame.

According to still another aspect of the present invention, there is provided a computer readable recording medium which stores a data frame which allows a multiple access in a chaotic communication system, wherein the data frame comprises a template unit in which a template chaotic signal is contained at a predetermined position allocated to a user, the template chaotic signal being available to the user; and a data unit containing a data bit frame obtained by combining the template chaotic signal with a data source signal to be transmitted.

### BRIEF DESCRIPTION OF THE DRAWINGS

Aspects of the present invention will become more apparent by describing in detail illustrative, non-limiting embodiments thereof with reference to the accompanying drawings, in which:

FIG. 1 is a schematic block diagram of a data transmission apparatus for enabling multiple access in a chaotic communication system according to an embodiment of the present invention;

FIG. 2 is a view of the structure of a data frame according to an embodiment of the present invention;

FIGS. 3A through 3C illustrate examples of the data frame shown in FIG. 2;

FIG. 4 is a schematic block diagram of a data receiving apparatus for enabling multiple access in a chaotic communication system according to an embodiment of the present invention;

FIG. 5 is a diagram illustrating a method of processing a signal in a data transmitting and receiving system according to an embodiment of the preset invention;

FIG. 6 is a flowchart of a method of transmitting data according to an embodiment of the preset invention; and

FIG. 7 is a flowchart of a method of receiving data according to an embodiment of the preset invention.

### DETAILED DESCRIPTION OF EXEMPLARY EMBODIMENTS OF THE INVENTION

Hereinafter, exemplary embodiments of the present invention will be described in detail with reference the accompanying drawings. Like reference numerals are used to designate like or equivalent elements throughout this disclosure.

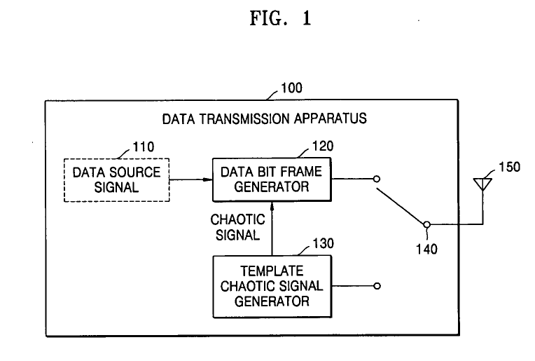

FIG. 1 is a schematic block diagram of a data transmission apparatus 100 for a multiple access in a chaotic communication system according to an embodiment of the present invention. The data transmission apparatus 100 includes a data bit frame generator 120, a template chaotic signal generator 130, a switch 140, and an antenna 150.

The template chaotic signal generator 130 generates a template chaotic signal that is available only to the data transmission apparatus 100 or a piconet to which the data transmission apparatus 100 is connected, and outputs the template chaotic signal to the switch 140 so that the template chaotic signal can be included into a predetermined part of a frame of data to be transmitted. The template chaotic signal is similar to noise and is randomly generated on a time axis. The template chaotic signal is input to the data bit frame generator 120 so that it can be used to modulate a data source signal 110.

The data bit frame generator 120 modulates the data source signal 110 by combining it with the template chaotic signal, and outputs the combined or modulated data source signal 110 to the switch 140 so that the modulated data source signal 110 can be included into a data frame.

Under the control of a controller (not shown), the switch 140 switches between the data bit frame generator 120 and the template chaotic signal generator 130, such that the template chaotic signal is included into a predetermined part of a data frame, which is to be output via the antenna 150, and a data bit frame is included into another part of the data frame.

The generated data frame is transmitted via the antenna 150.

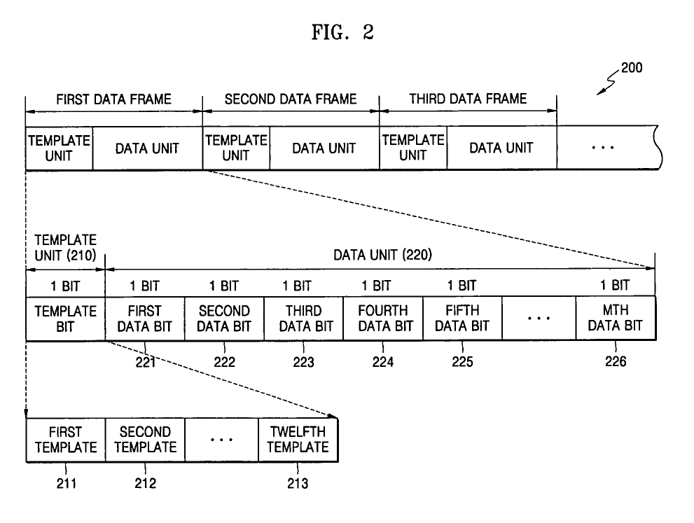

The structure of a data frame (or packet) 200 of a signal, which is generated by and transmitted from the data transmission apparatus 100 of FIG. 1, will now be described with reference to FIG. 2.

According embodiments consistent with the present invention, a data signal, which is transmitted from a data transmission apparatus to a data receiving apparatus, is divided into predetermined data frame units. Referring to FIG. 2, a data signal is comprised of a first data frame, a second data frame, a third data frame, and so on.

Each data frame includes a template unit and a data unit. The template unit contains a template chaotic signal, and the data unit contains data modulated using the template chaotic signal. A template chaotic signal in the first data frame may be the same as or different from a template chaotic signal in the second data frame, since the data receiving apparatus detects a chaotic template signal from the template unit of each data frame and modulates a data source signal using the detected chaotic template signal.

The construction of the first data frame will now be described in greater detail. Referring to FIG. 2, the data frame 200 includes a template unit 210 and a data unit 220. The template unit 210 is a 1-bit unit that contains a template chaotic signal, and thus may be referred to as a template bit. In the template unit 210, templates allocated to a plurality of users or a plurality of piconets are arranged at predetermined positions of the template unit 210.

Referring to FIG. 2, the template unit 210 includes a first template 211, a second template 212, . . . , and an nth template 213. The first template 211 is a part of the template unit 210 allocated to a first user or a first piconet, the second template 212 is a part of the template unit 212 allocated to a second user or a second piconet, and the nth template 213 is a part of the template unit 210 allocated to an nth user or an nth piconet. For instance, the template unit 210 of 1 bit is divided into four pieces, and the first through fourth pieces are allocated to the first through fourth piconets, respectively.

As described above, templates for respective users or piconets are arranged in the template unit 210 according to a predetermined order. Thus, even if a data frame is transmitted to a receiving side via a multichannel, the receiving side can detect a desired template based on its predetermined position within the data frame.

The data unit 220 includes a first data bit frame 221, a second data bit frame 222, a third data bit frame 223, a fourth data bit frame 224, a fifth data bit frame 225, . . . , an mth data bit frame 226. Even when a plurality of data signals are contained in the same portion of a data bit frame and the data bit frame is transmitted to a receiving side via a multichannel, the receiving side can exactly detect a data source signal from the data frame by matching the data signals contained within the data frame with its template.

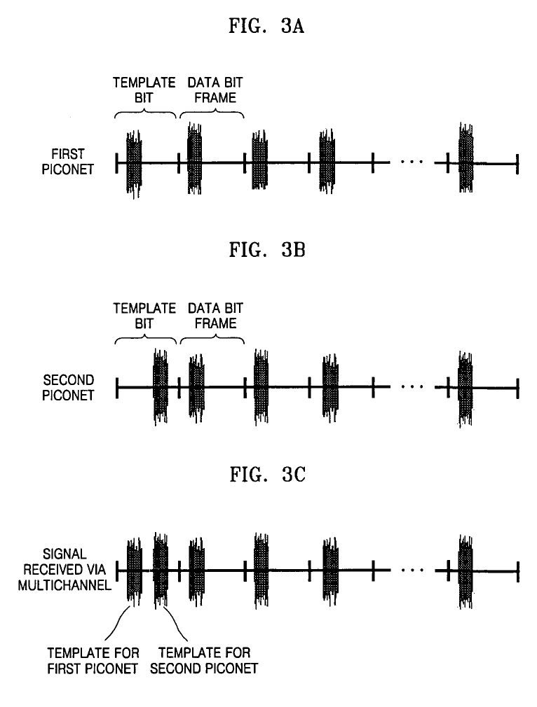

FIGS. 3A through 3C illustrate examples of the data frame shown in FIG. 2. When there are first and second piconets, a data frame template unit is divided into two pieces or portions: a first piece or portion is allocated to the first piconet and a second piece or portion is allocated to the second piconet.

Referring to FIG. 3A, a template for a first piconet is positioned in the first piece of the template bit of the data frame of the first piconet, and at least one data bit frame is contained in a data unit of the data frame.

Referring to FIG. 3B, a template for a second piconet is positioned in the second piece of the template bit of the data frame of the second piconet, and at least one data bit frame is contained in a data unit of the data frame.

Referring to FIG. 3C, the data frame of FIG. 3A overlaps with the data frame of FIG. 3B. However, although data bit frames of a data bit of the data frame of FIG. 3A overlap with those of a data bit of the data frame of FIG. 3B, the templates in the template bit of the data frame of FIG. 3A do not overlap with those of the template bit of the data frame of FIG. 3B. In this case, if the first or second piconet is aware of the position of its template, the first or second piconet can detect the template.

Specifically, if receiving apparatuses over the first piconet recognize that their template is included in a first piece of the template bit, the receiving sides detect the template from the first piece and extract a data source signal using the detected template.

Likewise, if receiving apparatuses over the second piconet recognize that their template is included in a second piece of the template bit, the receiving apparatuses detect the template from the second piece and extract a source signal using the detected template.

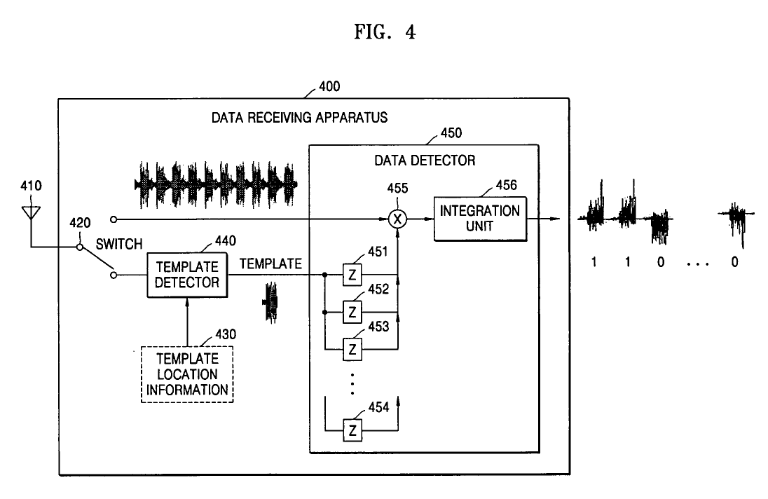

FIG. 4 is a schematic block diagram of a data receiving apparatus 400 for providing multiple access in a chaotic communication system according to an embodiment of the present invention. A data receiving apparatus 400 includes an antenna 410, a switch 420, a template detector 440, and a data detector 450.

The antenna 410 receives a data frame via a multichannel.

Under the control of a controller (not shown), the switch 420 switches between the template detector 440 and the data detector 450, such that a template unit of the data frame received via the antenna 410 is input to the template detector 440 and a data unit of the data frame is input to the data detector 450.

Upon receiving the template unit, the template detector 440 detects a desired template from the template unit according to template location information 430 stored in the template detector 440. If the template location information 430 indicates that the desired template is included in a last piece of the template unit, the template detector 440 detects the desired template from the last piece and transmits it to the data detector 450.

The data detector 450 receives a data unit of the data frame, excluding the template unit, and the template detected by the template detector 440, and extracts a data source signal from the received data unit.

Specifically, the data detector 450 includes delay circuits 451, 452, 453, . . . , 454 corresponding to data bit frames of the data frame, a multiplication unit 455, and an integration unit 456.

Each of the delay circuits 451, 452, 453, . . . , 454 stores a template received from the template detector 440.

The multiplication unit 455 performs a multiplication operation to compute the correlation between data bit frames in the data unit of the data frame and corresponding templates received from the delay circuits 451, 452, 453, . . . , 454, and sends the result of the multiplication operation to the integration unit 456. That is, the multiplication unit 455 performs the multiplication operation on each of data frames received in response to clock signals and a template delayed by each of the delay circuits 451, 452, 453, . . . , 454, and provides the multiplication result of operation to the integration unit 456.

The integration unit 456 integrates and outputs the results of the multiplication operation received from the multiplication unit 455.

According to the present invention, a data transmission apparatus transmits a data frame that includes a template and a signal modulated using the template to a data receiving apparatus. Thus, if the data receiving apparatus can detect the template, it can extract the modulated signal from the data frame using the template.

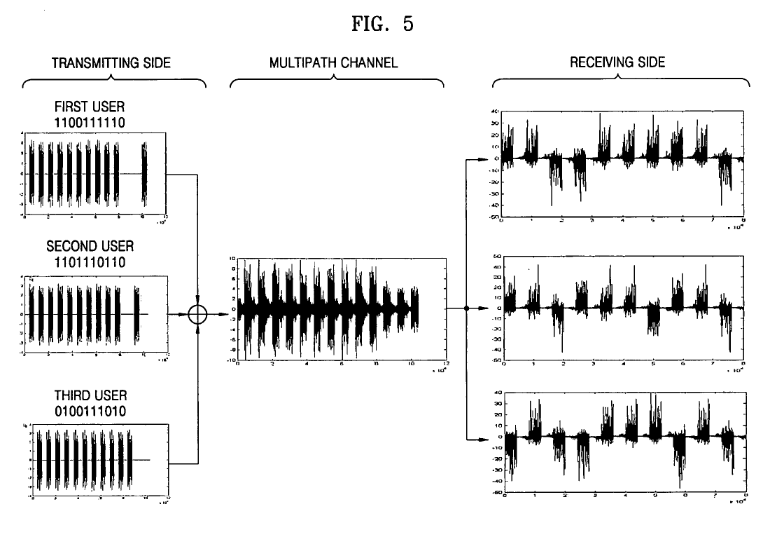

FIG. 5 is a diagram illustrating a process of processing a signal in a data transmitting and receiving system according to an embodiment of the present invention. Referring to FIG. 5, first through third users are connected to a transmitting side. According to an embodiment of the present invention, each of the three users includes a template at a predetermined position of a template unit of a data frame, modulates a data source signal using the template, and sends the data frame. It is assumed that the first user includes a template into a first piece of the template unit and sends data 1100111110, the second user includes a template into a second piece of the template and sends data 1101110110, and the third user includes a template in a third piece of the template and sends data 0100111010.

In this case, data frame signals transmitted by the first through third users are mixed while being transmitted via a multipath channel, and then, a mixture of the data frame signals is input to a receiving side.

Since a user on the receiving side of a piconet to which the first user belongs is aware that a desired template is contained in the first piece or portion of the template unit of the data frame, that user extracts the template from that first piece or portion and then uses that template to extract the data source signal from the data frame. Similarly, since a user on the receiving side of a piconet to which the second user belongs is aware that a desired template is contained in the second piece or portion of the template unit of the data frame, that user extracts the template from that second piece or portion and then uses that template to extract the data source signal from the data frame. Similarly still, since a user on the receiving side of a piconet to which the third user belongs is aware that a desired template is contained in the third piece or portion of the template unit, that user extracts the template from the third piece and uses that template to extract the data source signal from the data frame.

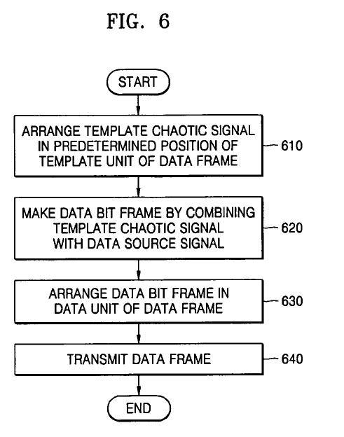

FIG. 6 is a flowchart of a method of transmitting data according to an embodiment of the present invention. Referring to FIG. 6, a data transmission apparatus arranges a template chaotic signal to be placed at a predetermined position of a template unit of a data frame, the position being allocated for a template of the data transmission apparatus (operation 610).

Next, the template chaotic signal is combined with a data source signal, thus making a data bit frame (operation 620).

Next, the data bit frame is arranged in a data unit of the data frame (operation 630).

Next, the data frame is transmitted to a data receiving apparatus (operation 640).

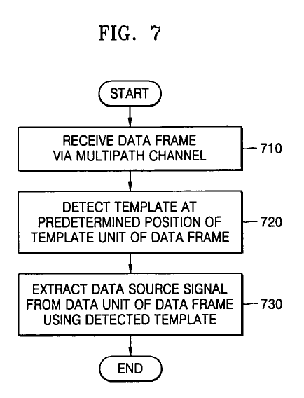

FIG. 7 is a flowchart of a method of receiving data according to an embodiment of the present invention. Referring to FIG. 7, a data frame is input to a data receiving apparatus via a multipath channel (operation 710).

Next, the data receiving apparatus detects a desired template at a predetermined position of a template unit of the data frame (operation 720).

Next, the data receiving apparatus extracts a data source signal from a data unit of the data frame by using the detected template (operation 730).

As described above, the present invention allows for effective multiple access in a chaotic communication system.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of transmitting data to provide multiple access in a chaotic communication system, the method comprising:
arranging a template chaotic signal at a predetermined position of a data frame to be transmitted, the predetermined position being allocated to a user;
modulating a data source signal using the template chaotic signal and arranging the modulated data source signal in the data frame; and
transmitting the data frame.

2. The method of claim 1, wherein during the arranging of the template chaotic signal, positions of the data frame, which are allocated to other users, are unoccupied.

3. A method of receiving data to provide multiple access in a chaotic communication system, the method comprising:
receiving a data frame via a multichannel;
detecting a template chaotic signal located at a predetermined position of the data frame, the predetermined position being allocated to a user; and
extracting a data source signal from the data frame using the template chaotic signal.

4. The method of claim 3, wherein during the extracting of the data source signal, the data source signal is extracted from the data frame according to a correlation between the template chaotic signal and a corresponding data bit frame of the data frame.

5. An apparatus for transmitting data to provide multiple access in a chaotic communication system, the apparatus comprising:
a chaotic signal generator arranging a template chaotic signal at a predetermined position of a data frame to be transmitted, the predetermined position being allocated to a user;
a data bit frame generator combining the template chaotic signal with a data source signal to be transmitted, and including a result of the combining into the data frame; and
a data transmission unit transmitting the data frame.

6. The apparatus of claim 5, wherein the chaotic signal generator is configured to prevent arranging said signals at positions of the data frame which are allocated to other users.

7. An apparatus for receiving data to provide multiple access in a chaotic communication system, the apparatus comprising:
a data receiving unit receiving a data frame via a multichannel;
a template detector detecting a template chaotic signal at a predetermined position of the data frame, the predetermined position being allocated to a user; and
a data extracting unit extracting a data source signal from the data frame using the template chaotic signal.

8. The apparatus of claim 7, wherein the data extracting unit extracts the data source signal according to a correlation between the template chaotic signal and a corresponding data bit frame of the data frame.

9. A computer readable recording medium which stores a data frame which allows for multiple access in a chaotic communication system, wherein the data frame comprises:
a template unit in which a template chaotic signal is contained at a predetermined position allocated to a user, the template chaotic signal being allocated to the user; and
a data unit containing a data bit frame obtained by combining the template chaotic signal with a data source signal to be transmitted.
